(19) United States
(12) Patent Application Publication
(10) Pub. No.: US 2016/0015068 A1
(43) Pub. Date: Jan. 21, 2016

(54) NUTRITIONAL FORMULAS CONTAINING OIL BLENDS AND USES THEREOF

(71) Applicant: Mead Johnson Nutrition Company, Glenview, IL (US)

(72) Inventors: Zihua Ao, Newburgh, IN (US); Dixie Carter, Salem, IN (US); Juan M. Gonzalez, Newburgh, IN (US); Colin Rudolph, San Francisco, CA (US)

(21) Appl. No.: 14/332,876

(22) Filed: Jul. 16, 2014

(51) Int. Cl. A23L 1/29

(52) U.S. Cl. CPC A23L 1/296; A23V 2002/00

(57) ABSTRACT

The present disclosure relates to a nutritional composition comprising a lipid source that includes an oil blend formulated with structured lipids comprising fatty acid triglycerides wherein about 10% to about 70% of the palmitic acid (C16:0) residues in the triglycerides are esterified at the sn-2 position. The oil blend may exhibit additive or synergistic beneficial health effects when consumed. The disclosure further relates to methods of aiding in and promoting digestion in a pediatric subject by providing a nutritional composition comprising an oil blend including structured lipids to targeted subjects.

### TECHNICAL FIELD

The present disclosure relates generally to nutritional compositions comprising an oil blend that includes structured lipids. In some embodiments, the oil blends disclosed herein include structured lipids which comprise fatty acid triglycerides, wherein about 10% to about 70% of the palmitic acid (C16:0) residues in the triglycerides are in the sn-2 position. The nutritional compositions are suitable for administration to pediatric subjects.

Additionally, the disclosure relates to methods of delivering lipid nutrition to a pediatric subject by providing a nutritional composition that includes an oil blend including structured lipids, comprising fatty acid triglycerides wherein about 10% to about 70% of the palmitic acid (C16:0) residues in the triglycerides are in the sn-2 position. The nutritional composition described herein may provide additive and or/synergistic beneficial health effects.

### BACKGROUND ART

Fat in most human milk and infant formulas provides 45-50% of energy and is present predominantly in the form of triglycerides. Generally, triglycerides contain one molecule of glycerol to which three fatty acids are esterified. The three stereo-specific positions of fatty acids are numbered as sn-1, sn2, and sn-3, respectively, or α (sn-1), β (sn-2), and α′ (sn-3) positions. (See FIG. 1)

The most abundant saturated fatty acid in human breast milk is palmitic acid (C16:0), which represents 15-25% of total fatty acids and contributes to about 10% of the breast-fed infant's total energy intake. It is found that the distribution of fatty acids on the backbone of glycerol in human breast milk shows remarkably high levels of saturated palmitic acid (C16:0) attached to the sn-2 position. For example, about 70% of the palmitic acid (C16:0) in human breast milk fat is esterified to the sn-2 position whereas the major unsaturated fatty acids, e.g., oleic acid (C18:1 (n-9)) and linoleic acid (C18:2 (n-6)), are esterified at the sn-1 and sn-3 positions. In comparison, vegetable oils have more than 80% of the palmitic acid (C16:0) esterified to the sn-1 and sn-3 positions and unsaturated fatty acids such as oleic acid (C18:1 (n-9)) and linoleic acid (C18:2 (n-6)) attached to the sn-2 position.

Further, the major pancreatic lipases in the human GI tract mainly hydrolyze triglycerides in the sn-1 and sn-3 positions to free two fatty acids and one 2-monoglyceride, which are absorbed into enterocytes. In infants, pancreatic lipase levels are low for the first months of life, especially in premature infants. Thus, fat digestion is largely depending upon lingual and gastric lipases which can hydrolyze triglycerides without disrupting the fat globule membrane. The end products of gastric fat digestion including, undigested triglycerides, diglycerides, monoglycerides, and fatty acids, pass into the small intestine.

Accordingly, having palmitic acid (C16:0) at the sn-2 positions on the triglycerides and included in an infant formula benefits the absorption of palmitic acid (C16:0) and may reduce unestererified palmitic acid (C16:0) interaction with minerals, which can form insoluble soap that can cause hardened stool. Additionally, inclusion of triglycerides having palmitic acid (C16:0) at the sn-2 position may promote lipid utilization, for example, the formation of complex lipids and molecular structures of cell membranes, which will promote brain development. Further, inclusion of triglycerides having palmitic acid (C16:0) at the sn-2 position may promote mineral absorption in infants. Yet further still, an increase of triglycerides having palmitic acid (C16:0) in the sn-2 position may potentially result in lipid metabolism more like that of breast milk in infants.

Accordingly, it would be beneficial to provide a nutritional composition that contains an oil blend formulated with structured lipids comprising fatty acid triglycerides wherein about 10% to about 70% of the palmitic acid (C16:0) residues in the triglycerides are esterified at the sn-2 position. Additionally, it is beneficial to provide a method of delivering lipid nutrition by providing a nutritional composition that contains a lipid source formulated with structured lipids comprising fatty acid triglycerides wherein about 10% to about 70% of the palmitic acid (C16:0) residues in the triglycerides are esterified at the sn-2 position.

Moreover, disclosed herein are methods for promoting cognition in a subject by administering a nutritional composition including a lipid source formulated with structured lipids comprising fatty acid triglycerides wherein about 10% to about 70% of the palmitic acid (C16:0) residues in the triglycerides are esterified at the sn-2 position. Additionally, disclosed herein are methods for promoting and/or aiding digestion in a pediatric subject by administering a nutritional composition that includes a lipid source having an oil blend including the structured lipids as described herein.

### BRIEF SUMMARY

The present disclosure is directed, in an embodiment, to a nutritional composition that contains a carbohydrate source, a protein source and a lipid source that includes the specific oil blends disclosed herein. In some embodiments the disclosure is directed to a nutritional composition that includes an oil blend having structured lipids comprising palmitic acid (C16:0) in the sn-2 position. In some embodiments, the oil blends include triglycerides having palmitic acid (C16:0) at the sn-2 position.

In some embodiments, the nutritional compositions disclosed herein may be in infant formula. Without being bound by any particular theory, the addition of an oil blend including triglycerides having palmitic acid (C16:0) at the sn-2 position may aid in and promote fat digestion in an infant or pediatric subject and further may promote cognitive development.

In some embodiments, the oil blends disclosed herein may comprise canola oil, which is low in erucic acid content, especially as compared to rapeseed oil. Still in some embodiments, the oil blends may include milk and/or milk fat components such as nutrients found in milk fat globule membranes, i.e. at least one ganglioside and at least one phospholipid. In some embodiments, the oil blends disclosed herein may comprise lard.

In certain embodiments the nutritional composition(s) may optionally contain least one probiotic, at least one prebiotic, a source of long chain polyunsaturated fatty acids (“LCPUFAs”), for example docosahexaenoic acid (“DHA”) and/or arachidonic acid (“ARA”), β-glucan, lactoferrin, a source of iron, and mixtures of one or more thereof.

Additionally, the disclosure is directed to a method of promoting and/or aiding in fat digestion in a pediatric subject by providing a nutritional composition having a lipid source and/or fat source that includes an oil blend having structured lipids comprising fatty acid triglycerides wherein about 10% to about 70% of the palmitic acid (C16:0) residues in the triglycerides are esterified at the sn-2 position.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### BRIEF DESCRIPTION OF THE DRAWINGS

FIG. 1 illustrates a general triglyceride structure.

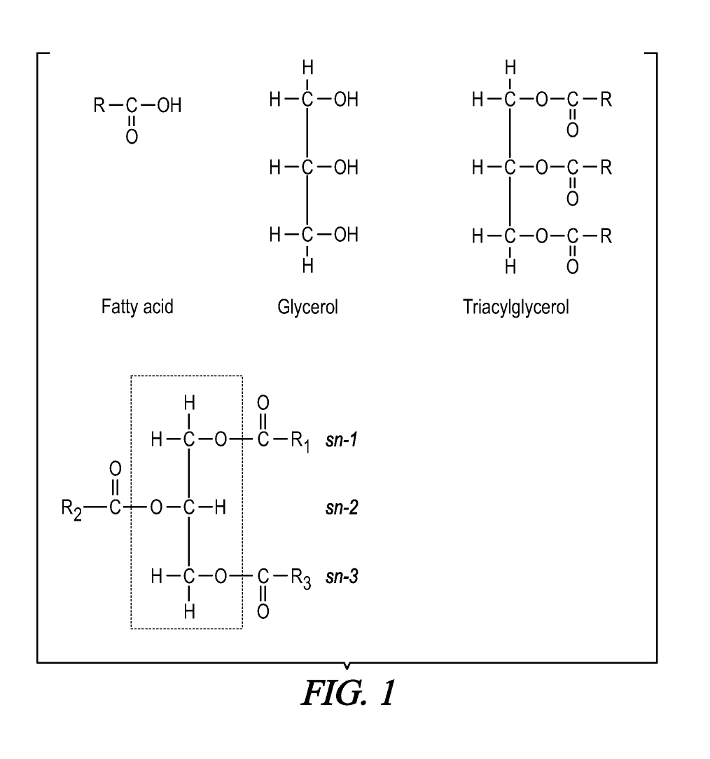

FIG. 2 shows the percent by weight of fatty acids for human milk, an internal control, and two oil blends including a source of structured lipids.

FIG. 3 illustrates the content of palmitic acid (C16:0) residues in the sn-2 position for the internal control, and two oil blends including a source of structured lipids.

FIG. 4 illustrates the percent by weight fatty acid profiles of an oil blend with soy, coconut, high oleic sunflower oil, canola oil, and a source of structured lipids as compared to human milk and an internal control.

FIG. 5 illustrates the percent by weight of fatty acids for human milk, an oil blend A including milkfat, a source of structured lipids, canola oil, corn oil, coconut oil and an oil blend B including a source of structured lipids, milkfat, soy oil, high oleic sunflower oil, and coconut oil (in this illustration, canola oil is referred to as rapeseed oil having low erucic acid levels).

FIG. 6 illustrates the percent by weigh of fatty acids of an oil blend A including lard, soy oil, coconut oil, high oleic sunflower oil, canola oil, and a source of structured lipids and an oil blend B including lard, soy oil, coconut oil, high oleic sunflower oil, and a source of structured lipids, as compared to human milk and an internal control.

### DETAILED DESCRIPTION

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

The present disclosure relates generally to nutritional compositions comprising a lipid source containing structured lipids. Additionally, the disclosure relates to methods of promoting cognitive development and aiding digestion in a pediatric subject by providing a nutritional composition comprising a lipid source that includes structured lipids as described herein.

“Nutritional composition” means a substance or formulation that satisfies at least a portion of a subject's nutrient requirements. The terms “nutritional(s)”, “nutritional formula(s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

“Pediatric subject” means a human less than 13 years of age. In some embodiments, a pediatric subject refers to a human subject that is between birth and 8 years old. In other embodiments, a pediatric subject refers to a human subject between 1 and 6 years of age. In still further embodiments, a pediatric subject refers to a human subject between 6 and 12 years of age. The term “pediatric subject” may refer to infants (preterm or full term) and/or children, as described below.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, extremely low birth weight infants and preterm infants. “Preterm” means an infant born before the end of the 37th week of gestation. “Late preterm” means an infant form between the 34th week and the 36th week of gestation. “Full term” means an infant born after the end of the 37th week of gestation. “Low birth weight infant” means an infant born weighing less than 2500 grams (approximately 5 lbs, 8 ounces). “Very low birth weight infant” means an infant born weighing less than 1500 grams (approximately 3 lbs, 4 ounces).

“Extremely low birth weight infant” means an infant born weighing less than 1000 grams (approximately 2 lbs, 3 ounces).

“Child” means a subject ranging in age from 12 months to about 13 years. In some embodiments, a child is a subject between the ages of 1 and 12 years old. In other embodiments, the terms “children” or “child” refer to subjects that are between one and about six years old, or between about seven and about 12 years old. In other embodiments, the terms “children” or “child” refer to any range of ages between 12 months and about 13 years.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

The term “degree of hydrolysis” refers to the extent to which peptide bonds are broken by a hydrolysis method. For example, the protein equivalent source of the present disclosure may, in some embodiments comprise hydrolyzed protein having a degree of hydrolysis of no greater than 40%. For this example, this means that at least 40% of the total peptide bonds have been cleaved by a hydrolysis method.

The term “partially hydrolyzed” means having a degree of hydrolysis which is greater than 0% but less than 50%.

The term “extensively hydrolyzed” means having a degree of hydrolysis which is greater than or equal to 50%.

“Probiotic” means a microorganism with low or no pathogenicity that exerts at least one beneficial effect on the health of the host.

In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such source is now known or later developed.

The term “inactivated probiotic” means a probiotic wherein the metabolic activity or reproductive ability of the referenced probiotic organism has been reduced or destroyed. The “inactivated probiotic” does, however, still retain, at the cellular level, at least a portion its biological glycol-protein and DNA/RNA structure. As used herein, the term “inactivated” is synonymous with “non-viable”. More specifically, a non-limiting example of an inactivated probiotic is inactivated Lactobacillus rhamnosus GG (“LGG”) or “inactivated LGG”.

The term “cell equivalent” refers to the level of non-viable, non-replicating probiotics equivalent to an equal number of viable cells. The term “non-replicating” is to be understood as the amount of non-replicating microorganisms obtained from the same amount of replicating bacteria (cfu/g), including inactivated probiotics, fragments of DNA, cell wall or cytoplasmic compounds. In other words, the quantity of non-living, non-replicating organisms is expressed in terms of cfu as if all the microorganisms were alive, regardless whether they are dead, non-replicating, inactivated, fragmented etc.

“Prebiotic” means a non-digestible food ingredient that beneficially affects the host by selectively stimulating the growth and/or activity of one or a limited number of bacteria in the digestive tract that can improve the health of the host.

“β-glucan” means all β-glucan, including specific types of β-glucan, such as β-1,3-glucan or β-1,3;1,6-glucan. Moreover, β-1,3;1,6-glucan is a type of β-1,3-glucan. Therefore, the term “β-1,3-glucan” includes β-1,3;1,6-glucan.

As used herein, “non-human lactoferrin” means lactoferrin which is produced by or obtained from a source other than human breast milk. In some embodiments, non-human lactoferrin is lactoferrin that has an amino acid sequence that is different than the amino acid sequence of human lactoferrin. In other embodiments, non-human lactoferrin for use in the present disclosure includes human lactoferrin produced by a genetically modified organism. The term “organism”, as used herein, refers to any contiguous living system, such as animal, plant, fungus or micro-organism.

“Inherent lutein” or “lutein from endogenous sources” refers to any lutein present in the formulas that is not added as such, but is present in other components or ingredients of the formulas; the lutein is naturally present in such other components.

All percentages, parts and ratios as used herein are by weight of the total composition, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified as the endpoint(s) of any range. Any reference to a range should be considered as providing support for any subset within that range.

The present disclosure is directed to nutritional compositions containing a carbohydrate source, a protein source, and a lipid source wherein the lipid source comprises an oil blend that includes triglycerides having palmitic acid (C16:0) residues at the sn-2 position.

Without being bound by any particular theory, it is believed that including triglycerides having palmitic acid (C16:0) at the sn-2 position will promote lipase access, especially lingual and gastric lipases thereby aiding in digestion. In certain embodiments, the structured lipids are in fluid form at body temperature.

In some embodiments, the nutritional compositions disclosed herein may include structured lipids comprising triglycerides having from about 10% to about 70% of the palmitic acid (C16:0) residues in sn-2 position, in a concentration of from about 50 mg/100 kcal to about 850 mg/100 kcal of nutritional composition.

Suitable sources for the structured lipids disclosed herein include, but are not limited to: Infat® manufactured by Advanced Lipids and Betapol 41, Betapol 45 and/or Betapol 55 (101 Loders Croklaan, Channahon, Ill.), lard, milkfat, and combinations thereof.

In some embodiments the oil blends disclosed herein may be comprised of soy oil, high oleic sunflower oil, a source of structured lipids and a DHA/ARA oil blend. In some embodiments the oil blend may comprise soy oil, high oleic sunflower oil, a source of structured lipids, and a DHA/ARA blend in a ratio of from about 10-25:3-12:60-90:1-10. In other words, the oil blend contains from 10-25 parts soy oil, from 3-12 parts high oleic sunflower oil, from 60-90 parts structured lipids, and from 1-10 parts DHA/ARA blend. Still, in other embodiments, the oil blend may comprise soy oil, a source of structured lipids, and a DHA/ARA blend in a ratio of from about 10-25:65-95:1-6 (i.e., from 10-25 parts soy oil, from 65-95 parts structured lipids, and from 1-6 parts DHA/ARA blend).

In some embodiments herein, the nutritional composition may comprise an oil blend wherein at least 10% of the total amount of palmitic acid (C16:0) residues in the triglycerides are in the sn-2 position. Still in some embodiments, the nutritional composition may comprise an oil blend wherein at least 20% of the total amount of the palmitic acid (C16:0) residues in the triglycerides are in the sn-2 position. In some embodiments, the nutritional composition may comprise an oil blend wherein at least 30% of the total amount of the palmitic acid (C16:0) residues in the triglycerides are in the sn-2 position. In some embodiments, the nutritional composition may comprise an oil blend wherein at least 40% of the total amount of the palmitic acid (C16:0) residues in the triglycerides are in the sn-2 position.

In some embodiments, the oil blends disclosed herein may include canola oil. In some embodiments, canola oil may replace some or all of expensive high oleic sunflower oil and bring more stable levels of alpha-linolenic acid C18:3(n-3), which is an important precursor of DHA synthesis. In addition, inclusion of canola oil may also improve the ratio of linoleic Cl 8:2(n-6) to alpha-linolenic acid in the oil blend.

Further, when formulating nutritional compositions, it can be a challenge to control the quality of soy oil due to the variability of linolenic acid and linoleic acid. Accordingly, in some embodiments, canola oil may be included instead of soy oil or may replace a portion of the soy oil in the oil blend, which may reduce a risk of seasonal or soy seed change on two essential fatty acids linoleic acid and alpha-linolenic acid, as compared to soy oil.

Accordingly, in some embodiments the oil blend(s) disclosed herein comprise canola oil and a source of structured lipids. In some embodiments, the oil blend may comprise 10-30 parts soy oil, 10-32 parts coconut oil, 5-15 parts high oleic sunflower oil, 3-15 parts canola oil, and 30-50 parts of a source of structured lipids (i.e., a ratio of soy oil to coconut oil to high oleic sunflower oil to canola oil to source of structured lipids of 10-30:10-32:5-15:3-15:30-50).

In some embodiments, the oil blend comprises canola low erucic oil and a source of structured lipids, wherein at least 10% of the palmitic acid (C16:0) residues in the triglycerides are in the sn-2 position. In some embodiments, the oil blend comprises canola oil and a source of structured lipids, wherein at least 20% of the palmitic acid (C16:0) residues in the triglycerides are in the sn-2 position. Still in some embodiments, the oil blend comprises canola oil and a source of structured lipids, wherein at least 30% of the palmitic acid (C16:0) residues in the triglycerides are in the sn-2 position. In some embodiments, the oil blend comprises canola oil and a source of structured lipids, wherein at least 40% of the palmitic acid (C16:0) residues in the triglycerides are in the sn-2 position.

The oil blend may, in some embodiments, comprise cow's milkfat, rather than or in addition to the canola oil. In certain countries, India, for example, milkfat is a preferred lipid source in infant formulas. Accordingly, in some embodiments disclosed herein, the oil blend may comprise a source of milkfat and a source of structured lipids. In some embodiments, the oil blend comprises a source of milkfat and at least one other source of structured lipids. In some embodiments, the oil blend comprises a source of milkfat and at least one other source of structured lipids in a ratio of 25:10 to about 50:25.

In certain embodiments, about 25% to about 55% of the oil blend is comprised of milkfat. Still in some embodiments, about 20% to about 45% of the oil blend is comprised of milkfat. In some embodiments, about 10% to about 25% of the oil blend is comprised of milkfat.

In embodiments of the present disclosure, the oil blend may comprise milkfat, a source of structured lipids, canola oil, corn oil, and coconut oil in a ratio of from about 35-60:10-30:10-20:2-20:2-20. In still other embodiments the oil blend may comprise a source of structured lipids, milkfat, soy oil, high oleic sunflower oil, and coconut oil in a ratio of from about 20-50:15-35:10-30:5-25.

In embodiments, the oil blend comprises milkfat and a source of structured lipids, wherein at least 10% of the total amount of palmitic acid (C16:0) residues in the triglycerides in the overall oil blend are in the sn-2 position. Still in some embodiments, the oil blend comprises milkfat and a source of structured lipids, wherein at least 20% of the total amount of palmitic acid (C16:0) residues in the fatty acid triglycerides in the overall oil blend are in the sn-2 position. In some embodiments, the oil blend comprises milkfat and a source of structured lipids, wherein at least 30% of the total amount of palmitic acid (C16:0) residues in the fatty acid triglycerides in the overall oil blend are in the sn-2 position. Still in some embodiments, the oil blend comprises milkfat and a source of structured lipids, wherein at least 40% of the total amount of palmitic acid (C16:0) residues in the fatty acid triglycerides in the oil blend are in the sn-2 position.

In certain embodiments, where the oil blend includes milkfat, palm olein oil may be completely removed from the oil blend and may be further completely removed from the nutritional composition. In some embodiments the oil blends that include milkfat and exclude palm olein oil, may be suitable for formulating infant formulas and pediatric nutritional compositions in certain countries where milkfat is preferred, for example India. Further, in embodiments where milkfat is included in the oil blend, the oil blend may further comprise conjugated linoleic acid, branched fatty acids, phospholipids, sphingolipids, and combinations thereof.

Moreover, in some embodiments where milkfat is included in the oil blend, the oil blend will comprise endogenous short chain fatty acids which originate from milkfat. Suitable short chain fatty acids found in milkfat that may be included in the oil blends disclosed herein include, but are not limited to: oleic acid, palmitic acid, propionic acid, isobutyric acid, butyric acid, stearic acid, lauric acid (C12), myristic acid (C14), and combinations thereof. Additionally, the inclusion of milkfat and the short chain fatty acids therein will promote fat digestion and provide a rapid source of energy.

Without being bound by any particular theory, it is believed that the inclusion of milkfat, which includes short chain fatty acids, and the structured lipids disclosed herein having palmitic acid (C16:0) at the sn-2 position in the triglycerides, may act synergistically in combination to promote fat digestion and fat absorption when administered.

In some embodiments the oil blend(s) disclosed herein may include lard. In some embodiments, lard may be incorporated into the oil blend as a source of structured lipids comprising triglycerides having palmitic acid (C16:0) in the sn-2 position. Still in some embodiments, the oil blend may include both lard and at least one other source of structured lipids.

Briefly, lard is well absorbed and includes triglycerides having almost 80% of the palmitic acid (C16:0) residues at the sn-2 position. Further, the inclusion of lard in the oil blend will provide an oil blend that is formulated to be compositionally closer to animal fat and human milk fatty acid profiles. In some embodiments, lard may be incorporated and blended with other vegetable oils and a source of structured lipids, such that at least 50% of the palmitic acid (C16:0) present in the overall oil blend would be in the sn-2 position.

In some embodiments, the oil blend comprises lard and at least one other source of structured lipids in a ratio of from about 15-50:18-50. In some embodiments, where the oil blend includes lard, at least 10% of the palmitic acid (C16:0) present in the triglycerides is in the sn-2 position. In some embodiments, where the oil blend includes lard, at least 20% of the palmitic acid (C16:0) present in the triglycerides is in the sn-2 position. In some embodiments, where the oil blend includes lard, at least 30% of the palmitic acid (C16:0) present in the triglycerides is in the sn-2 position. In some embodiments, where the oil blend includes lard, at least 40% of the palmitic acid (C16:0) present in the triglycerides is in the sn-2 position.

In some embodiments the nutritional compositions disclosed herein comprise an oil blend that includes lard, wherein the nutritional composition is an infant formula suitable for administration to premature infants, low-birth-weight infants, very-low birth weight infants, and/or extremely-low-birth-weight infants. Still in some embodiments, the nutritional composition that comprises an oil blend that includes lard is a human milk fortifier product.

Additional structured lipids that may be included in the oil blend(s) disclosed herein include, but are not limited to: triglycerides with palmitic acid in the sn-2 position and short chain fatty acids (such as acetic acid, butyric acid) in the sn-1 and sn-2 positions; triglycerides with palmitic acid in the sn-2 position and medium chain fatty acids in the sn-1 and sn-3 positions; triglycerides with essential fatty acids, such as linoleic, linolenic, DHA, and/or ARA, in the sn-2 position and medium chain fatty acids in the sn-1 and sn-3 positions; triglycerides with long chain polyunsaturated fatty acids, such as linoleic, linolenic, eicosapentaenoic acid (EPA), DHA and/or ARA, in the sn-2 position and monounsaturated fatty acids, for example oleic acid, in the sn-1 and sn-3 positions; triglycerides with nervonic acid (C24:1)(n-9) in the sn-2 position and medium chain fatty acids and/or monounsaturated fatty acids in the sn-1 and sn-3 positions.

Without being bound by any particular theory, these additional structured lipids and the structured lipids including triglycerides having palmitic acid (C16:0) in the sn-2 position may increase fatty acid absorption, reduce fat absorption related disorders, and may further enhance physiologic and pharmacologic effects such as promoting neural and retinal development in prenates, neonates/infants, children, and/or pediatric subjects.

In some embodiments, the oil blend may further comprise a source of milk fat globule membrane (MFGM), complex lipids, and/or sphingomyelin. In some embodiments, the source of MFGM or complex lipids may be provided by Lacprodan®MFGM-10 available from Arla. Briefly, Lacprodan®MFGM-10 includes phospholipids in which sphingomyelin (SM) is enriched, and reportedly includes 70-76% protein, 3% lactose, 14-18% fat; more specifically, MFGM-10 comprises 6-8% phospholipid, 5% IgG, 1.0-2.0% Sphingomyelin (SM), 0.2-0.3% Ganglioside (GM3, GD3), and 0.15% Lactoferrin. SM is the main phospholipid having nervonic acid esterified to the glycerol backbone. Dietary nervonic acid may support the normal synthesis and functionality of myelin in both brain and nervous tissue. Further, many current infant formulas include a low content of sphingomyelin.

In some embodiments, the oil blend may include a source of gangliosides. For example in some embodiments, the source of gangliosides may be Ganglioside 600 (G600) from Fonterra), which reportedly comprises 10% protein, 58% lactose, 30% fat, 12% phospholipids, 1.7% gangliosides and 1.7% sphingomyelin. Briefly, G600 is a complex milk lipid source, which includes gangliosides, and is manufactured or extracted during butter production. Studies have shown that inclusion of ingredients containing gangliosides in nutritional composition, may promote cognitive development.

Inclusion of phospholipid and ganglioside containing ingredients, such as butter, milk, cream, phospholipid enriched whey protein concentrate, in combination with the structured lipids disclosed herein would bring the overall lipid profile of the oil blend closer to that of human milk. Accordingly, the oil blends disclosed herein may be formulated to include structured lipids, wherein at least 40% of the palmitic acid (16:0) residues present in the triglycerides are in sn-2 position, and may be enriched with sphingomyelin, gangliosides, and combinations thereof.

In some embodiments, the nutritional composition(s) disclosed herein comprise an oil blend wherein from about 1% to about 5% of the oil blend includes lipid from a source of MFGM, complex lipids, and/or sphingomyelin. Further, in some embodiments the concentrations of the following phospholipids and gangliosides in the oil blend of the nutritional composition are as follows: from about 60 mg/L to about 85 mg/L sphingomyelin (SM), from about 70 mg/L to about 95 mg/L phosphatidyl ethanolamine (PE), from about 70 mg/L to about 95 mg/L phosphatidyl choline (PC), from about 15 mg/L to about 30 mg/L phosphatidyl inositol (PI), from about 22 mg/L to about 47 mg/L phosphatidyl serine, from about 15 mg/L to about 30 mg/L of other phospholipids, and from about 3 mg/L to about 17 mg/L ganglioside (GD3). In general, these ranges may not include phospholipids from non-animal milk sources, such as soy lecithin, sunflower lecithin, egg lecithin, which could be used in these formulas.

Additionally, a combination of structured lipids with phospholipid enriched milk ingredients, such as WPC Lacprodan® MFGM-10 from Arla, have been shown to have functional benefit in regard to cognitive development. Accordingly, in some embodiments the oil blends disclosed herein may include the structured lipids disclosed herein and further include a source of phospholipid enriched milk ingredients. Without being bound by any particular theory, addition of structured lipids, phospholipids, and/or milk ingredients may provide additive and/or synergistic effects and is likely to better support cognitive development.

In some embodiments, the nutritional composition(s) disclosed herein comprise an oil blend wherein from about 0.5% to about 5% of the oil blend comprises lipid from a source of phospholipid enriched milk ingredients. Further, in some embodiments, the oil blend includes the following: from about 65 mg/L to about 90 mg/L sphingomyelin (SM), from about 50 mg/L to about 70 mg/L phosphatidyl ethanolamine (PE), from about 75 mg/L to about 90 mg/L phosphatidyl choline (PC), from about 25 mg/L to about 40 mg/L phosphatidyl inositol (PI), from about 20 mg/L to about 40 mg/L phosphatidyl serine, from about 5 mg/L to about 20 mg/L of other phospholipids, and from about 2.5 mg/L to about 17 mg/L ganglioside (GD3).

Accordingly, in some embodiments, the oil blend(s) disclosed herein comprises structured lipids including triglycerides having palmitic acid (C16:0) in the sn-2 position, and is further enriched with a source of phospholipids and/or a source of gangliosides.

In some embodiments, the lipid source of the present disclosure comprises phospholipids from about 50 mg/100 kcal to about 400 mg/100 kcal. In other embodiments, the enriched lipid fraction of the present disclosure may comprise phospholipids from about 75 mg/100 kcal to about 150 mg/100 kcal. In yet other embodiments, the enriched lipid fraction comprises phospholipids from about 100 mg/100 kcal to about 250 mg/100 kcal.

Phospholipids are found in human milk lipids at levels of about 20 to 40 mg/dl. Further, the phospholipid composition of human milk lipids, as the weight percent of total phospholipids, is phosphatidylcholine (“PC”) 24.9%, phosphatidylethanolamine (“PE”) 27.7%, phosphatidylserine (“PS”) 9.3%, phosphatidylinositol (“PI”) 5.4%, and sphingomyelin (“SPGM”) 32.4%, (Harzer, G. et al., Am. J. Clin. Nutr., Vol. 37, pp. 612-621, 1983). Thus in one embodiment, the enriched lipid fraction comprises one or more of PC, PE, PS, PI, SPGM, and mixtures thereof.

In some embodiments, once the desired oil blend disclosed herein is obtained, it may be incorporated into the nutritional composition(s) described herein by any method well-known in the art. In some embodiments, the oil blend may be substituted for other oils that are normally included in the fat and/or lipid source of the nutritional composition. For example, the oil blend may be substituted for vegetable oils, such as palm olein, soy, coconut, and high oleic sunflower oils.

In some embodiments, the oil blend (s) disclosed herein may be added to the nutritional composition by replacing an equivalent amount of the rest of the overall fat blend normally present in the nutritional composition. In some embodiments, a certain amount of oil used as a lipid source, that does not contain the oil blend wherein the triglycerides comprise 10% to 70% of the palmitic acid (C16:0) residues in the sn-2 position may be substituted with the oil blend that includes triglycerides having 10% to 70% of the palmitic acid (C16:0) residues in the sn-2 position.

Still in some embodiments, the oil blends disclosed herein may be the sole fat and/or lipid source incorporated into the nutritional composition. In some embodiments, wherein the oil blend(s) disclosed herein are the sole fat and/or lipid source for the nutritional composition, the resultant nutritional composition will include an oil blend including triglycerides having at least 40% of the palmitic acid (C16:0) residues in the sn-2 position.

In one embodiment, where the nutritional composition is an infant formula, the oil blend including structured lipids may be added to a commercially available infant formula. For example, Enfalac, Enfamil®, Enfamil® Premature Formula, Enfamil® with Iron, Enfamil® LIPIL®, Lactofree®, Nutramigen®, Pregestimil®, and ProSobee® (available from Mead Johnson & Company, Evansville, Ind., U.S.A.) may be supplemented with the oil blend including structured lipids, and used in practice of the current disclosure.

In some embodiments, the oil blend(s) comprising the structured lipids disclosed herein may be included in prenatal dietary supplements. The oil blend(s) disclosed herein may be incorporated into prenatal dietary supplements by any method known in the art. The prenatal administration of the oil blend comprising the structured lipids disclosed herein may directly impact the development of the fetus and embryo. Since brain development begins early in prenatal life, the inclusion of the oils blends including structured lipids in a prenatal dietary supplement may promote brain development and neurogenesis in pediatric subjects while still in utero.

Conveniently, commercially available prenatal dietary supplements and/or prenatal nutritional products may be used. For example, Expecta® Supplement (available from Mead Johnson Nutrition Company, Glenview, Ill., U.S.A.) may be supplemented with suitable levels of the oil blend(s) including structured lipids and used in practice of the present disclosure.

The prenatal dietary supplement may be administered in one or more doses daily. In some embodiments, the prenatal dietary supplement is administered in two doses daily. In a separate embodiment, the prenatal dietary supplement is administered in three daily doses. The prenatal dietary supplement may be administered to either pregnant women or women who are breastfeeding.

Any orally acceptable dosage form is contemplated by the present disclosure. Examples of such dosage forms include, but are not limited to pills, tablets, capsules, soft-gels, liquids, liquid concentrates, powders, elixirs, solutions, suspensions, emulsions, lozenges, beads, cachets, and combinations thereof. Alternatively, the prenatal dietary supplement of the invention may be added to a more complete nutritional product. In this embodiment, the nutritional product may contain protein, fat, and carbohydrate components and may be used to supplement the diet or may be used as the sole source of nutrition.

The nutritional composition(s) of the present disclosure may also comprise a carbohydrate source. Carbohydrate sources can be any used in the art, e.g., lactose, glucose, fructose, corn syrup solids, maltodextrins, sucrose, starch, rice syrup solids, isomaltulose, and the like. The total amount of carbohydrate in the nutritional composition typically can vary from between about 5 g and about 25 g/100 kcal. In some embodiments, the amount of carbohydrate is between about 6 g and about 22 g/100 kcal. In other embodiments, the amount of carbohydrate is between about 12 g and about 14 g/100 kcal. In some embodiments, corn syrup solids are preferred. Moreover, hydrolyzed, partially hydrolyzed, and/or extensively hydrolyzed carbohydrates may be desirable for inclusion in the nutritional composition due to their easy digestibility. Specifically, hydrolyzed carbohydrates are less likely to contain allergenic epitopes.

Non-limiting examples of carbohydrate materials suitable for use herein include hydrolyzed or intact, naturally or chemically modified, starches sourced from corn, tapioca, rice or potato, in waxy or non-waxy forms. Non-limiting examples of suitable carbohydrates include various hydrolyzed starches characterized as hydrolyzed cornstarch, maltodextrin, maltose, corn syrup, dextrose, corn syrup solids, glucose, and various other glucose polymers and combinations thereof. Non-limiting examples of other suitable carbohydrates include those often referred to as sucrose, lactose, fructose, high fructose corn syrup, isomaltulose, indigestible oligosaccharides such as fructooligosaccharides and combinations thereof.

The nutritional composition(s) of the disclosure may also comprise a protein source. The protein source can be any used in the art, e.g., nonfat milk, whey protein, casein, soy protein, rice protein, pea protein, potato protein, hydrolyzed protein, amino acids, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In one embodiment, the proteins of the nutritional composition are provided as intact proteins. In other embodiments, the proteins are provided as a combination of both intact proteins and partially hydrolyzed proteins, with a degree of hydrolysis of between about 4% and 10%. In certain other embodiments, the proteins are more hydrolyzed. In still other embodiments, the protein source comprises amino acids. In yet another embodiment, the protein source may be supplemented with glutamine-containing peptides.

In a particular embodiment of the nutritional composition, the whey:casein ratio of the protein source is similar to that found in human breast milk. In an embodiment, the protein source comprises from about 40% to about 80% whey protein and from about 20% to about 70% casein.

In some embodiments, the nutritional composition comprises between about 1 g and about 7 g of a protein source per 100 kcal. In other embodiments, the nutritional composition comprises between about 3.5 g and about 4.5 g of protein per 100 kcal.

In some embodiments, the nutritional composition described herein comprises a lipid source. The enriched lipid fraction described herein may be the sole lipid source or may be used in combination with any other suitable fat or lipid source for the nutritional composition as known in the art. Appropriate lipid sources include, but are not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

In some embodiments the nutritional composition may also include a source of LCPUFAs. In one embodiment the amount of LCPUFA in the nutritional composition is from about 5 mg/100 kcal to about 100 mg/100 kcal. Still in some embodiments, the amount of LCPUFA in the nutritional composition is from about 10 mg/100 kcal to about 50 mg/100 kcal. Non-limiting examples of LCPUFAs include, but are not limited to, DHA, ARA, linoleic (18:2 n-6), γ-linolenic (18:3 n-6), dihomo-γ-linolenic (20:3 n-6) acids in the n-6 pathway, α-linolenic (18:3 n-3), stearidonic (18:4 n-3), eicosatetraenoic (20:4 n-3), eicosapentaenoic (20:5 n-3), and docosapentaenoic (22:6 n-3).

In some embodiments, the LCPUFA included in the nutritional composition may comprise DHA. In one embodiment the amount of DHA in the nutritional composition is from about 5 mg/100 kcal to about 75 mg/100 kcal. Still in some embodiments, the amount of DHA in the nutritional composition is from about 10 mg/100 kcal to about 50 mg/100 kcal.

In another embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The DHA and ARA can be in natural form, provided that the remainder of the LCPUFA source does not result in any substantial deleterious effect on the infant. Alternatively, the DHA and ARA can be used in refined form.

The disclosed nutritional composition described herein can, in some embodiments, also comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000; 120:413-431.)

β-1,3-glucans are naturally occurring polysaccharides, with or without β-1,6-glucose side chains that are found in the cell walls of a variety of plants, yeasts, fungi and bacteria. β-1,3;1,6-glucans are those containing glucose units with (1,3) links having side chains attached at the (1,6) position(s). β-1,3;1,6 glucans are a heterogeneous group of glucose polymers that share structural commonalties, including a backbone of straight chain glucose units linked by a β-1,3 bond with β-1,6-linked glucose branches extending from this backbone. While this is the basic structure for the presently described class of β-glucans, some variations may exist. For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

In some embodiments, the β-glucan is β-1,3;1,6-glucan. In some embodiments, the β-1,3;1,6-glucan is derived from baker's yeast. The nutritional composition may comprise whole glucan particle β-glucan, particulate β-glucan, PGG-glucan (poly-1,6-β-D-glucopyranosyl-1,3-β-D-glucopyranose) or any mixture thereof.

In some embodiments, the amount of β-glucan in the nutritional composition is between about 3 mg and about 17 mg per 100 kcal. In another embodiment the amount of β-glucan is between about 6 mg and about 17 mg per 100 kcal.

The disclosed nutritional composition described herein can, in some embodiments, also comprise a source of probiotic. Any probiotic known in the art may be acceptable in this embodiment. In a particular embodiment, the probiotic may be selected from any Lactobacillus species, Lactobacillus rhamnosus GG (ATCC number 53103), Bifidobacterium species, Bifidobacterium longum BB536 (BL999, ATCC: BAA-999), Bifidobacterium longum AH1206 (NCIMB: 41382), Bifidobacterium breve AH1205 (NCIMB: 41387), Bifidobacterium infantis 35624 (NCIMB: 41003), and Bifidobacterium animalis subsp. lactis BB-12 (DSM No. 10140) or any combination thereof.

If included, the nutritional composition may comprise between about 1×10⁴ to about 1.5×10¹⁰ cfu of probiotics per 100 kcal, more preferably from about 1×10⁶ to about 1×10⁹ cfu of probiotics per 100 kcal.

In an embodiment, the probiotic(s) may be viable or non-viable. The probiotics useful in the present disclosure may be naturally-occurring, synthetic or developed through the genetic manipulation of organisms, whether such new source is now known or later developed.

The disclosed nutritional composition described herein can, in some embodiments, also comprise a source of prebiotics. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide, and gentio-oligosaccharides. In one preferred embodiment, the prebiotic comprises galacto-oligosaccharide, polydextrose, or mixtures thereof.

The amount of galacto-oligosaccharide in the nutritional composition may, in an embodiment, be from about 0.1 mg/100 kcal to about 1.0 mg/100 kcal. In another embodiment, the amount of galacto-oligosaccharide in the nutritional composition may be from about 0.1 mg/100 kcal to about 0.5 mg/100 kcal. The amount of polydextrose in the nutritional composition may, in an embodiment, be within the range of from about 0.1 mg/100 kcal to about 0.5 mg/100 kcal. In another embodiment, the amount of polydextrose may be about 0.3 mg/100 kcal. In a particular embodiment, galacto-oligosaccharide and polydextrose are supplemented into the nutritional composition in a total amount of at least about 0.2 mg/100 kcal and can be about 0.2 mg/100 kcal to about 1.5 mg/100 kcal. In some embodiments, the nutritional composition may comprise galactooligosaccharide and polydextrose in a total amount of from about 0.6 to about 0.8 mg/100 kcal.

The nutritional composition of the present disclosure, may comprise lactoferrin. Lactoferrins are single chain polypeptides of about 80 kD containing 1-4 glycans, depending on the species. The 3-D structures of lactoferrin of different species are very similar, but not identical. Each lactoferrin comprises two homologous lobes, called the N- and C-lobes, referring to the N-terminal and C-terminal part of the molecule, respectively. Each lobe further consists of two sub-lobes or domains, which form a cleft where the ferric ion (Fe3+) is tightly bound in synergistic cooperation with a (bi)carbonate anion. These domains are called N1, N2, C1 and C2, respectively. The N-terminus of lactoferrin has strong cationic peptide regions that are responsible for a number of important binding characteristics. Lactoferrin has a very high isoelectric point (˜pI 9) and its cationic nature plays a major role in its ability to defend against bacterial, viral, and fungal pathogens. There are several clusters of cationic amino acids residues within the N-terminal region of lactoferrin mediating the biological activities of lactoferrin against a wide range of microorganisms.

Lactoferrin for use in the present disclosure may be, for example, isolated from the milk of a non-human animal or produced by a genetically modified organism. The nutritional compositions described herein can, in some embodiments comprise non-human lactoferrin, non-human lactoferrin produced by a genetically modified organism and/or human lactoferrin produced by a genetically modified organism.

Suitable non-human lactoferrins for use in the present disclosure include, but are not limited to, those having at least 48% homology with the amino acid sequence of human lactoferrin. For instance, bovine lactoferrin (“bLF”) has an amino acid composition which has about 70% sequence homology to that of human lactoferrin. In some embodiments, the non-human lactoferrin has at least 65% homology with human lactoferrin and in some embodiments, at least 75% homology. Non-human lactoferrins acceptable for use in the present disclosure include, without limitation, bLF, porcine lactoferrin, equine lactoferrin, buffalo lactoferrin, goat lactoferrin, murine lactoferrin and camel lactoferrin.

bLF suitable for the present disclosure may be produced by any method known in the art. For example, in U.S. Pat. No. 4,791,193, incorporated by reference herein in its entirety, Okonogi et al. discloses a process for producing bovine lactoferrin in high purity. Generally, the process as disclosed includes three steps. Raw milk material is first contacted with a weakly acidic cationic exchanger to absorb lactoferrin followed by the second step where washing takes place to remove nonabsorbed substances. A desorbing step follows where lactoferrin is removed to produce purified bovine lactoferrin. Other methods may include steps as described in U.S. Pat. Nos. 7,368,141, 5,849,885, 5,919,913 and 5,861,491, the disclosures of which are all incorporated by reference in their entirety.

In certain embodiments, lactoferrin utilized in the present disclosure may be provided by an expanded bed absorption (“EBA”) process for isolating proteins from milk sources. EBA, also sometimes called stabilized fluid bed adsorption, is a process for isolating a milk protein, such as lactoferrin, from a milk source comprises establishing an expanded bed adsorption column comprising a particulate matrix, applying a milk source to the matrix, and eluting the lactoferrin from the matrix with an elution buffer comprising about 0.3 to about 2.0 M sodium chloride. Any mammalian milk source may be used in the present processes, although in particular embodiments, the milk source is a bovine milk source. The milk source comprises, in some embodiments, whole milk, reduced fat milk, skim milk, whey, casein, or mixtures thereof.

In particular embodiments, the target protein is lactoferrin, though other milk proteins, such as lactoperoxidases or lactalbumins, also may be isolated. In some embodiments, the process comprises the steps of establishing an expanded bed adsorption column comprising a particulate matrix, applying a milk source to the matrix, and eluting the lactoferrin from the matrix with about 0.3 to about 2.0M sodium chloride. In other embodiments, the lactoferrin is eluted with about 0.5 to about 1.0 M sodium chloride, while in further embodiments, the lactoferrin is eluted with about 0.7 to about 0.9 M sodium chloride.

The expanded bed adsorption column can be any known in the art, such as those described in U.S. Pat. Nos. 7,812,138, 6,620,326, and 6,977,046, the disclosures of which are hereby incorporated by reference herein. In some embodiments, a milk source is applied to the column in an expanded mode, and the elution is performed in either expanded or packed mode. In particular embodiments, the elution is performed in an expanded mode. For example, the expansion ratio in the expanded mode may be about 1 to about 3, or about 1.3 to about 1.7. EBA technology is further described in international published application nos. WO 92/00799, WO 02/18237, WO 97/17132, which are hereby incorporated by reference in their entireties.

The isoelectric point of lactoferrin is approximately 8.9. Prior EBA methods of isolating lactoferrin use 200 mM sodium hydroxide as an elution buffer. Thus, the pH of the system rises to over 12, and the structure and bioactivity of lactoferrin may be comprised, by irreversible structural changes. It has now been discovered that a sodium chloride solution can be used as an elution buffer in the isolation of lactoferrin from the EBA matrix. In certain embodiments, the sodium chloride has a concentration of about 0.3 M to about 2.0 M. In other embodiments, the lactoferrin elution buffer has a sodium chloride concentration of about 0.3 M to about 1.5 M, or about 0.5 m to about 1.0 M.

The lactoferrin that is used in certain embodiments may be any lactoferrin isolated from whole milk and/or having a low somatic cell count, wherein “low somatic cell count” refers to a somatic cell count less than 200,000 cells/mL. By way of example, suitable lactoferrin is available from Tatua Co-operative Dairy Co. Ltd., in Morrinsville, New Zealand, from FrieslandCampina Domo in Amersfoort, Netherlands or from Fonterra Co-Operative Group Limited in Auckland, New Zealand.

Surprisingly, lactoferrin included herein maintains certain bactericidal activity even if exposed to a low pH (i.e., below about 7, and even as low as about 4.6 or lower) and/or high temperatures (i.e., above about 65° C., and as high as about 120° C.), conditions which would be expected to destroy or severely limit the stability or activity of human lactoferrin. These low pH and/or high temperature conditions can be expected during certain processing regimen for nutritional compositions of the types described herein, such as pasteurization. Therefore, even after processing regimens, lactoferrin has bactericidal activity against undesirable bacterial pathogens found in the human gut.

The nutritional composition may, in some embodiments, comprise lactoferrin in an amount from about 10 mg/100 kcal to about 250 mg/100 kcal. In some embodiments, lactoferrin may be present in an amount of from about 50 mg/100 kcal to about 175 mg/100 kcal. Still in some embodiments, lactoferrin may be present in an amount of from about 100 mg/100 kcal to about 150 mg/100 kcal.

The disclosed nutritional composition described herein, can, in some embodiments also comprise an effective amount of iron. The iron may comprise encapsulated iron forms, such as encapsulated ferrous fumarate or encapsulated ferrous sulfate or less reactive iron forms, such as ferric pyrophosphate or ferric orthophosphate.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In embodiments providing a nutritional composition for a child, the composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In embodiments providing a children's nutritional product, such as a growing-up milk, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to growing-up milks or to other children's nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

The nutritional compositions of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

The nutritional compositions of the disclosure may provide minimal, partial or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals. The amount of lipid or fat typically can vary from about 1 to about 25 g/100 kcal. The amount of protein typically can vary from about 1 to about 7 g/100 kcal. The amount of carbohydrate typically can vary from about 6 to about 22 g/100 kcal.

In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

In some embodiments the nutritional composition is an infant formula. Infant formulas are fortified nutritional compositions for an infant. The content of an infant formula is dictated by federal regulations, which define macronutrient, vitamin, mineral, and other ingredient levels in an effort to simulate the nutritional and other properties of human breast milk. Infant formulas are designed to support overall health and development in a pediatric human subject, such as an infant or a child.

In some embodiments, the nutritional composition of the present disclosure is a growing-up milk. Growing-up milks are fortified milk-based beverages intended for children over 1 year of age (typically from 1-3 years of age, from 4-6 years of age or from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of a growing-up milk or other nutritional composition according to the present disclosure can vary from market-to-market, depending on local regulations and dietary intake information of the population of interest. In some embodiments, nutritional compositions according to the disclosure consist of a milk protein source, such as whole or skim milk, plus added sugar and sweeteners to achieve desired sensory properties, and added vitamins and minerals. The fat composition includes an enriched lipid fraction derived from milk. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

The disclosed nutritional composition(s) may be provided in any form known in the art, such as a powder, a gel, a suspension, a paste, a solid, a liquid, a liquid concentrate, a reconstituteable powdered milk substitute or a ready-to-use product. The nutritional composition may, in certain embodiments, comprise a nutritional supplement, children's nutritional product, infant formula, human milk fortifier, growing-up milk or any other nutritional composition designed for an infant or a pediatric subject. Nutritional compositions of the present disclosure include, for example, orally-ingestible, health-promoting substances including, for example, foods, beverages, tablets, capsules and powders. Moreover, the nutritional composition of the present disclosure may be standardized to a specific caloric content, it may be provided as a ready-to-use product, or it may be provided in a concentrated form. In some embodiments, the nutritional composition is in powder form with a particle size in the range of 5 μm to 1500 μm, more preferably in the range of 10 μm to 300 μm.

Further, the disclosure provides methods of aiding in and promoting digestion in a pediatric subject by providing a nutritional composition comprising an oil blend including triglycerides, wherein about 10% to about 70% of the palmitic acid (C16:0) residues are in the sn-2 position, to targeted subjects. In some embodiments, the nutritional composition provided further comprises at least one of the following: a carbohydrate source, a protein source, a lipid source, a source of long chain polyunsaturated fatty acids, a probiotic, a prebiotic, β-glucan, lactoferrin, a source of iron, and combinations thereof.

In some embodiments, the disclosure provides methods of promoting cognitive development in a pediatric subject by providing a nutritional composition comprising an oil blend including triglycerides, wherein about 10% to about 70% of the palmitic acid (C16:0) residues are in the sn-2 position, to targeted subjects.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

Included below are specific example oil blends including the structured lipids disclosed herein that may be suitable for practice of the present disclosure.

Example 1 introduces oil blends that include triglycerides having palmitic acid (C16:0) at the sn-2 position, which can be incorporated into the nutritional composition(s) of the present disclosure.

### Example 1

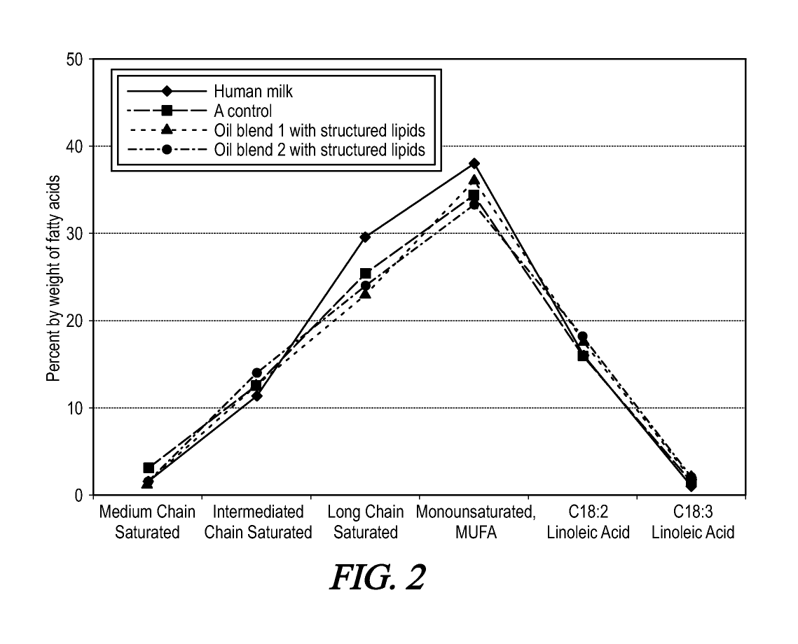

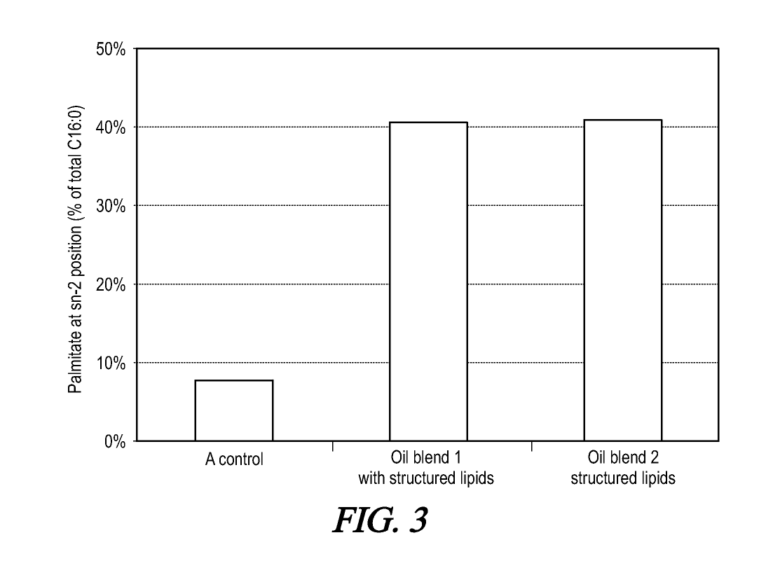

Illustrated in FIGS. 2 and 3 is a lipid profile in which the structured lipid source Betapol 45 is used to make an oil blend having a high amount of triglycerides including palmitic acid (C16:0) in the sn-2 position. FIG. 2 shows the comparison of fatty acids in the oil blends as a percent by weight of the total fatty acids. The four oil blends tested include human milk, a control oil blend, Oil Blend 1 with Betapol 45, and Oil Blend 2 with Betapol 45. Oil Blend 1 was made with soy oil, high oleic sunflower oil, Betapol 45 and DHA/ARA blend in a ratio of 16:5.8:75:3.2. Oil Blend 2 was made with soy oil, Betapol 45 and DHA/ARA blend in a ratio of 16.8:80:3.2. Further, as shown in FIG. 3, at least 40% of the palmitic acid (C16:0) residues present in the triglycerides of Oil Blend 1 and Oil blend 2 are in the sn-2 position.

Example 2 provides an oil blend comprising canola oil and structured lipids.

### Example 2

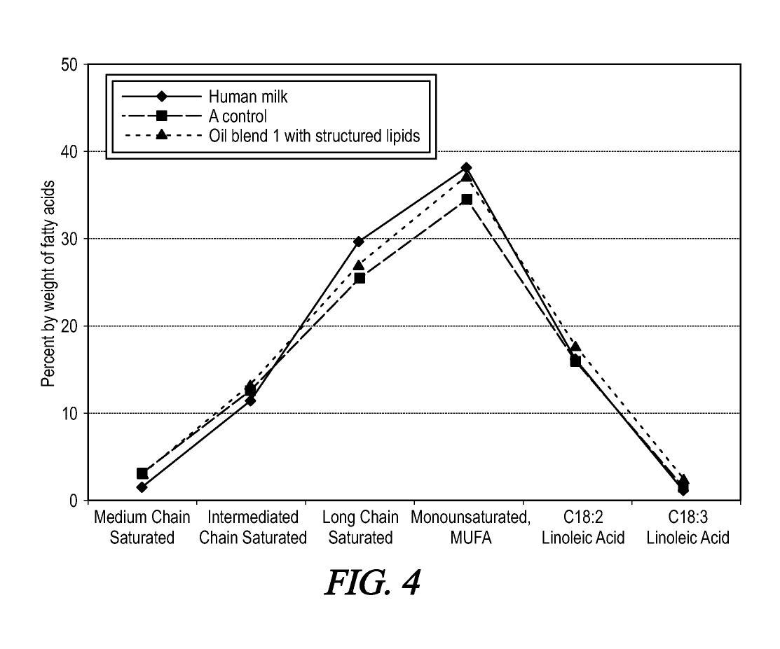

Illustrated in FIG. 4 is a lipid profile in which Betapol 55, a specially formulated commercially available structured lipid source, is used to make an oil blend having a high amount of palmitic acid (C16:0) in the sn-2 position on the triglycerides included therein. Betapol 55 is a concentrated product manufacture for further blending to achieve a desired fatty acid profile. Additionally, Oil Blend with Betapol 55 as shown in FIG. 4 is formulated with canola oil to control the quality of the overall oil blend. Oil Blend with Betapol 55 includes soy oil, coconut oil, high oleic sunflower oil, canola oil, and Betapol 55 in a ratio of 22:20:8:7:43, respectively. Further, FIG. 4 shows the fatty acid profiles of Oil Blend with Betapol 55 as compared to human milk and MJN control.

Example 3 illustrates an oil blend that includes milkfat and structured lipids.

### Example 3

Provided in Example 3 is a blend of structured lipids, other vegetable oils, and cow's milkfat in that includes an increased content of triglycerides having palmitic acid (C16:0) in the sn-2 position. Further, given the addition of milkfat in this embodiment, the fatty acid profiles of the oil blend also includes more short chain fatty acids that originate from milkfat. Additionally, in some embodiments where milkfat is utilized, palm olein oil may be completely removed from the oil blend.

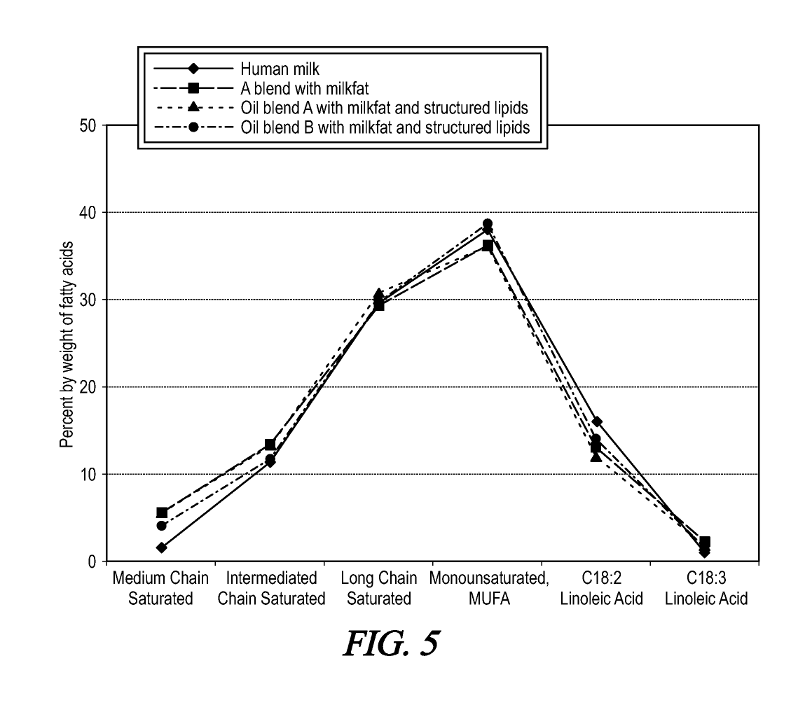

Further, as shown in FIG. 5, is an oil blend that includes milkfat, Betapol 55, canola oil, corn oil, and coconut oil in a ratio of 45:18:17:10:10. Additionally, as shown in FIG. 5, is a second oil blend that includes Betapol 55, milkfat, soy oil, high oleic sunflower oil, and coconut oil in a ratio of 30:25:18:15:12.

Example 4 provides an oil blend that comprises lard and a source of structured lipids.

### Example 4

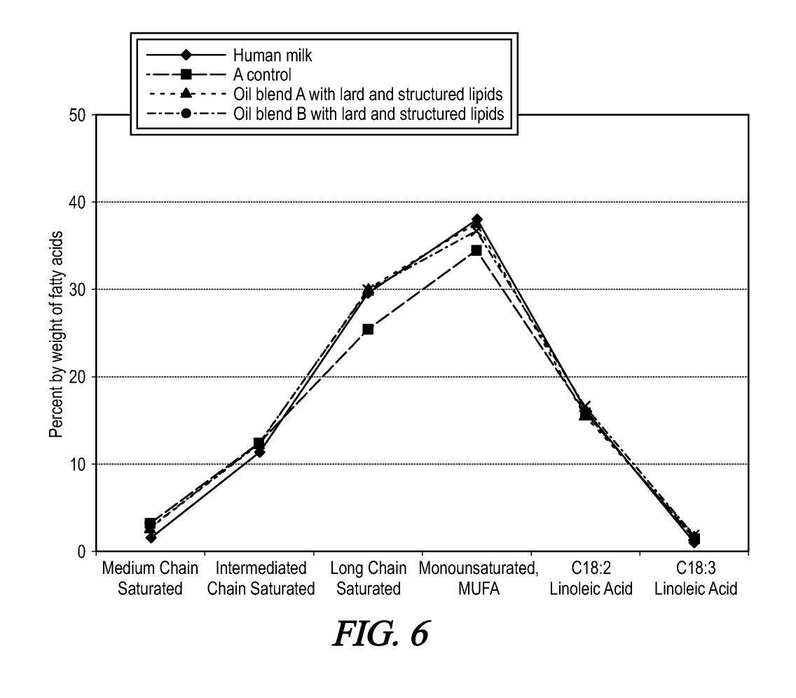

FIG. 6 shows an oil blend that includes lard, soy oil, coconut oil, high oleic sunflower oil, canola oil, and structured lipid Betapol 55 in a ratio of 30:16.6:18:3.5:3.5:28.4, respectively. Another oil blend includes lard, soy oil, coconut oil, high oleic sunflower oil, and a source of structured lipids in a ratio of 32:20:18:5:25.

Formulation examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with all the examples disclosed herein, be considered to be exemplary only, with the scope and spirit of the disclosure being indicated by the claims, which follow the examples.

### Formulation Examples

Tables 1-6 illustrate formulations, which include triglycerides wherein at least 35% or more of the palmitic acid (C16:0) present is in the sn-2 position.

### Table 1

Table 1, illustrated below, provides an example embodiment of the nutritional profile of a soy protein based formula that includes an oil blend having structured lipids as described herein.

TABLE 1
Nutrition profile of a soy protein based
formula including structure lipids

| Ingredient | Amount per 100 g | |
|---|---|---|
| Corn Syrup Solids | 52.87 | g |
| Fat blend with structured | 25.4 | g |
| lipids | | |
| Soy protein | 15 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Vitamin, taurine and | 1.2 | g |
| methionine mix | | |
| Iron trituration | 0.2 | g |
| Trace/ultratrace minerals | 0.12 | g |

### Table 2

Table 2, below, provides an example embodiment of the nutritional profile of an amino acid based formula that includes an oil blend having structured lipids as described herein.

TABLE 2
Nutrition profile of an amino acid based formula

| Ingredient | Amount per 100 g | |
|---|---|---|
| Corn Syrup Solids | 40.56 | g |
| Fat blend with structured | 25.1 | g |
| lipids | | |
| ARA and DHA | 0.7 | g |
| OSA-modified starch | 9 | g |
| Calcium phosphate | 1.6 | g |
| Calcium citrate | 0.4 | g |
| Calcium hydroxide | 0.15 | g |
| Choline chloride | 0.18 | g |
| Potassium chloride | 0.2 | g |
| Potassium citrate | 1.3 | g |
| Sodium citrate | 0.3 | g |
| Magnesium oxide | 0.1 | g |
| L-carnitine | 0.01 | g |
| Sodium iodide | 0.1 | mg |
| Amino acid mix | 19.6 | g |
| Vitamin mix | 0.4 | g |
| Trace/ultra trace minerals | 0.2 | g |
| Iron trituration | 0.2 | g |

### Table 3

Table 3, below, provides an example embodiment of the nutritional profile of a partially hydrolyzed milk protein based formula that includes an oil blend having structured lipids as described herein.

TABLE 3
Nutrition profile of a partially hydrolyzed
milk protein based formula

| Ingredient | Amount per 100 g | |
|---|---|---|
| Corn Syrup Solids | 49.9 | g |
| Partially Hydrolyzed milk | 24.2 | g |
| protein solids | | |
| Fat blend with structured | 23.6 | g |
| lipids | | |
| ARA and DHA | 0.7 | g |
| Calcium carbonate | 0.4 | g |
| Calcium phosphate | 0.4 | g |
| Potassium Chloride | 0.18 | g |
| Choline chloride | 0.12 | g |
| Magnesium Phosphate | 0.09 | g |
| L-carnitine | 0.01 | g |
| Vitamin and taurine mix | 0.26 | g |
| Trace/ultra trace minerals | 0.17 | g |
| Iron trituration | 0.17 | g |

### Table 4

Table 4, below, provides an example embodiment of the nutritional profile of a milk protein based formula that includes an oil blend having structured lipids as described herein.

TABLE 4
Nutrition profile of a milk based formula

| Ingredient | Amount per 100 g | |
|---|---|---|
| Lactose | 39.76 | g |
| Non-fat dry milk and whey | 27.2 | g |
| protein concentrate | | |
| Fat blend with structured | 25 | g |
| lipids | | |
| Prebiotics (GOS and PDX) | 5.1 | g |
| Lecithin | 0.4 | g |
| ARA and DHA | 0.7 | g |
| Calcium Carbonate | 0.4 | g |
| Calcium Phosphate | 0.2 | g |
| Potassium Chloride | 0.18 | g |
| Choline Chloride | 0.12 | g |
| Magnesium Phosphate | 0.09 | g |
| L-Carnitine | 0.01 | g |
| Vitamin and taurine mix | 0.3 | g |
| Trace/ultra trace minerals | 0.17 | g |
| Nucleotides | 0.2 | g |
| Iron trituration | 0.17 | g |

### Table 5

Table 5 below, provides an example embodiment of the nutritional profile of a milk protein based formula that includes an oil blend having structured lipids and a source of milk fat globule membrane (MFGM).

TABLE 5
Nutrition profile of a milk based formula

| Ingredient | Amount per 100 g | |
|---|---|---|
| Lactose | 40.3 | g |
| Non-fat dry milk and whey | 23.5 | g |
| protein concentrate | | |
| Fat blend with structured | 24.7 | g |
| lipids | | |
| Prebiotics (GOS and PDX) | 5.1 | g |
| Lacprodan ®MFGM-10 | 3.73 | g |
| Lecithin | 0.4 | g |
| ARA and DHA | 0.7 | g |
| Calcium Carbonate | 0.4 | g |
| Calcium Phosphate | 0.2 | g |
| Potassium Chloride | 0.18 | g |
| Choline Chloride | 0.12 | g |
| Magnesium Phosphate | 0.09 | g |
| L-Carnitine | 0.01 | |
| Vitamin and taurine mix | 0.3 | g |
| Trace/ultra-trace minerals | 0.17 | g |
| Nucleotides | 0.2 | g |
| Iron trituration | 0.17 | g |

### Table 6

Table 6 below, provides an example embodiment of the nutritional profile of a milk protein based formula that includes an oil blend having structured lipids, a source of milk fat globule membrane (MFGM), and lactoferrin.

TABLE 6
Nutrition profile of a milk based formula

| Ingredient | Amount per 100 g | |
|---|---|---|
| Lactose | 41.25 | g |
| Non-fat dry milk and whey | 22 | g |
| protein concentrate | | |
| Fat blend with structured | 24.7 | g |
| lipids | | |
| Prebiotics (GOS and PDX) | 5.1 | g |
| Lacprodan ®MFGM-10 | 3.73 | g |
| Lactoferrin | 0.55 | |
| Lecithin | 0.4 | g |
| ARA and DHA | 0.7 | g |
| Calcium Carbonate | 0.4 | g |
| Calcium Phosphate | 0.2 | g |
| Potassium Chloride | 0.18 | g |
| Choline Chloride | 0.12 | g |
| Magnesium Phosphate | 0.09 | g |
| L-Carnitine | 0.01 | |
| Vitamin and taurine mix | 0.3 | g |
| Trace/ultra-trace minerals | 0.17 | g |
| Nucleotides | 0.2 | g |
| Iron trituration | 0.17 | g |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

What is claimed is:

1. A nutritional composition comprising:
a carbohydrate source,
a protein source, and
a lipid source comprising an oil blend comprising structured lipids,
wherein the structured lipids comprise triglycerides having about 10% to about 70% of the palmitic acid (C16:0) residues in the triglycerides are esterified at the sn-2 position.

2. The nutritional composition of claim 1, wherein the structured lipids comprise triglycerides having from about 40% to about 70% of the palmitic acid (C16:0) residues at the sn-2 position.

3. The nutritional composition of claim 1, wherein the structured lipids comprise triglycerides having from about 20% to about 40% of the palmitic acid (C16:0) residues at the sn-2 position.

4. The nutritional composition of claim 1, wherein the source of the structured lipids comprise lard.

5. The nutritional composition of claim 1, wherein the oil blend further comprises as least one ingredient selected from canola oil, milkfat, and cream.

6. The nutritional composition of claim 1, wherein the lipid source further comprises cholesterol.

7. The nutritional composition of claim 6, wherein the lipid source comprises cholesterol from about 10 mg/100 kcal to about 400 mg/100 kcal.

8. The nutritional composition of claim 1, wherein the lipid source further comprises at least one phospholipid.

9. The nutritional composition of claim 1, wherein the lipid source further comprises a source of milk fat globule membrane.

10. The nutritional composition of claim 1, further comprising DHA.

11. The nutritional composition of claim 1, further comprising at least one probiotic.

12. The nutritional composition of claim 1, further comprising at least one prebiotic.

13. The nutritional composition of claim 1, further comprising β-glucan.

14. The nutritional composition of claim 1, wherein the nutritional composition is an infant formula.

15. A nutritional composition, comprising per 100 kcal:
(i) between about 6 g and about 22 g of a carbohydrate source;
(ii) between about 1 g and about 7 g of a protein source;
(iii) between about 1 g and about 10.3 g of a lipid source comprising an oil blend including structured lipids, wherein the structured lipids comprise triglycerides having about 10% to about 70% of the palmitic acid (C16:0) residues in sn-2 position.

16. A method of promoting fat and lipid digestion in a pediatric subject comprising providing a nutritional composition comprising a carbohydrate source, a protein source, and a lipid source comprising structured lipids, wherein the structured lipids comprise triglycerides wherein about 10% to about 70% of the palmitic acid (C16:0) residues are at the sn-2 position.

17. The method of claim 16, wherein the lipid source further comprises cholesterol.

18. The method of claim 16, wherein the nutritional composition further comprises a source of long chain polyunsaturated fatty acids.

19. The method of claim 16, wherein the nutritional composition further comprises at least one nutrient selected from the group consisting of the following: a probiotic, a prebiotic, β-glucan, lactoferrin, a source of iron, and combinations thereof.

20. The method of claim 16, wherein the nutritional composition is an infant formula.
